(19) United States
(12) Patent Application Publication
(10) Pub. No.: US 2018/0367971 A1
(43) Pub. Date: Dec. 20, 2018

(54) INFORMATION PROCESSING DEVICE, INFORMATION PROCESSING METHOD, STORAGE MEDIUM AND INFORMATION PROCESSING SYSTEM

(71) Applicant: Casio Computer Co., Ltd., Tokyo (JP)

(72) Inventor: Kazunori Yanagi, Tokyo (JP)

(21) Appl. No.: 16/012,367

(22) Filed: Jun. 19, 2018

(30) Foreign Application Priority Data
Jun. 20, 2017 (JP) 2017-120710

(51) Int. Cl. H04W 4/38; H04W 52/02

(52) U.S. Cl. CPC H04W 4/38; H04W 52/0235; H04W 52/0261

(57) ABSTRACT

When sensor information required for the operation of application software is to be acquired after communication between a portable terminal and a mobile device is established, if a sensor device which acquires this sensor information exists in each device, sensor information to be used is selected from among those of the sensor devices based on predetermined conditions, and predetermined control processing is performed by the application software by using the selected sensor information.

### CROSS-REFERENCE TO RELATED APPLICATION

This application is based upon and claims the benefit of priority from the prior Japanese Patent Application No. 2017-120710, filed Jun. 20, 2017, the entire contents of which are incorporated herein by reference.

### BACKGROUND OF THE INVENTION

### 1. Field of the Invention

The present invention relates to an information processing device, an information processing method, a storage medium and an information processing system.

### 2. Description of the Related Art

Conventionally, a technique has been devised in which, when certain processing is to be performed, external environment information is acquired to be used therefor.

For example, Japanese Laid-Open (Kokai) Patent Application 2006-093931 discloses a system constituted by a wirelessly connected digital camera and a wristwatch provided with a sensor device. In this technique, when a shutter trigger occurred in the digital camera is transmitted to the wristwatch, the wristwatch transmits a measurement value measured thereby to the digital camera, and this measurement value is stored in association with a file that is based on an image generated by the image capturing.

Also, in recent years, there is a technique where such wirelessly connected devices each have a sensor and a certain program is executed using sensor information from these sensors.

### SUMMARY OF THE INVENTION

In accordance with one aspect of the present invention, there is provided an information processing device, comprising: a sensor which acquires sensor information based on an external environment; a reception section which receives sensor information whose type is same as type of the sensor information that is acquired by the sensor, from outside the information processing device; and a control section, wherein the control section selects one of the sensor information that is acquired by the sensor and the sensor information that is received by the reception section, and performs predetermined control processing by using the selected sensor information.

In accordance with another aspect of the present invention, there is provided an information processing method, comprising: a selection step of selecting one of sensor information that is acquired by a sensor mounted in a device and sensor information that is received from outside; and a control step of performing predetermined control processing by using the selected sensor information.

In accordance with another aspect of the present invention, there is provided a non-transitory computer-readable storage medium having stored thereon a program that is executable by a computer including a sensor which acquires sensor information based on an external environment and a reception section, the program being executable by the computer to actualize functions comprising: a reception function for receiving sensor information whose type is same as type of the sensor information that is acquired by the sensor, from outside via the reception section; a selection function for selecting one of the sensor information that is acquired by the sensor and the sensor information that is received from outside; and a control function for performing predetermined control processing by using the sensor information selected by the selection function.

In accordance with another aspect of the present invention, there is provided an information processing device, comprising: a sensor which acquires sensor information based on an external environment; a communication section which communicates externally; and a control section, wherein the control section makes an external request to transmit information required for selecting one of the sensor information that is acquired by the sensor and sensor information that is provided from outside, via the communication section, wherein the control section controls the communication section to receive the information that is transmitted from outside in response to the request, and wherein the control section performs predetermined control processing by selectively using one of the sensor information that is acquired by the sensor and the sensor information that is provided from outside, based on the information received by the communication section.

In accordance with another aspect of the present invention, there is provided an information processing system constituted by an information processing device, a mobile device, and a server, wherein the information processing device comprises a first sensor which acquires first sensor information based on an external environment and a control section, wherein the mobile device comprises a second sensor which acquires second sensor information based on an external environment, wherein the server has sensor-related information regarding the first sensor and the second sensor, and comprises a transmission section which transmits information that is based on the sensor-related information and is required to select one of the first sensor information and the second sensor information to the information processing device in response to a request from the information processing device or the mobile device, and wherein the control section of the information processing device performs predetermined control processing by selectively using one of the first sensor information and the second sensor information based on the information transmitted from the server.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a diagram showing the configuration of an information processing system according to an embodiment of the present invention;

FIG. 2 is a block diagram showing the structure of a portable terminal 10 according to the embodiment;

FIG. 3 is a block diagram showing the structure of a mobile device 20 (digital camera 20) according to the embodiment;

FIG. 4 is a diagram showing the configuration of an application software table 50 according to the embodiment;

FIG. 5 is a diagram showing the configuration of a connected-device table 60 according to the embodiment; and

FIG. 6 is a flowchart for describing operations of the portable terminal 10 according to the embodiment.

### DETAILED DESCRIPTION OF THE PREFERRED EMBODIMENTS

An embodiment of the present invention will hereinafter be described with reference to the drawings.

### A. Configuration of Embodiment

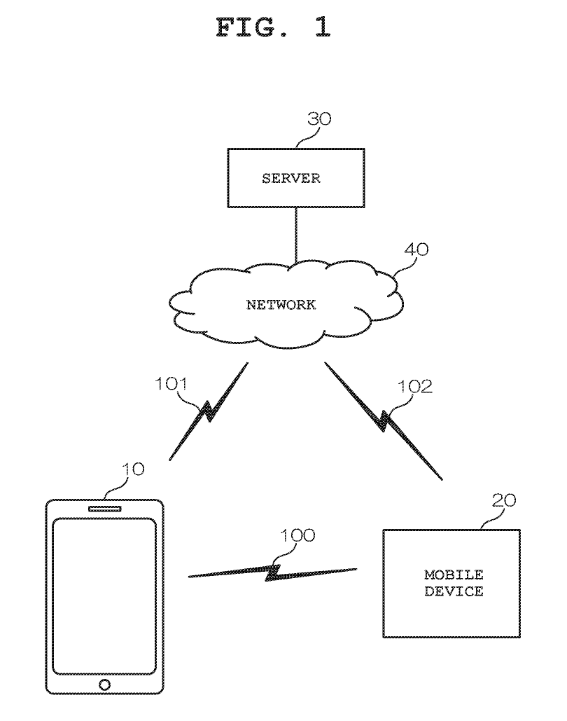

FIG. 1 is a diagram showing the configuration of an information processing system according to an embodiment of the present invention. The information processing system in FIG. 1 is constituted by a portable terminal 10, a mobile device 20, and a server 30. The portable terminal 10 is a mobile phone, a smartphone, or the like. The mobile device 20 is a digital camera, a wristwatch having a built-in sensor (such as a smartwatch), a sensing device having a built-in GPS (Global Positioning System), or the like. The server 30 is connected to a network 40 constituted by the Internet or the communication network of a telecommunications carrier.

The portable terminal 10 establishes wireless communication 100 with the mobile device 20 by using Bluetooth (registered trademark) or a wireless LAN (Local Area Network) such as WiFi (Wireless Fidelity: registered trademark) which is available to both the portable terminal 10 and the mobile device 20, and transmits and receives data (information from various sensors) required for the operation of arbitrary application software.

Also, the portable terminal 10 is connected to the network 40, such as the Internet, via a base station (not shown) by using wireless communication 101 (a communication link, WiFi (registered trademark), or the like), and transmits or receives various data to or from the server 30 on the network 40.

The mobile device 20 establishes the wireless communication 100 with the portable terminal 10 by using Bluetooth (registered trademark) or a wireless LAN such as WiFi (registered trademark) which is available to both the mobile device 20 and the portable terminal 10, and transmits and receives data (information from various sensors) required for the operation of arbitrary application software.

Also, the mobile device 20 is connected to the network 40, such as the Internet, via a base station (not shown) by using wireless communication 102 (a communication link, WiFi (registered trademark), or the like), and transmits or receives various data to or from the server 30 on the network 40.

In this embodiment, when the portable terminal 10 is to acquire data (information from a sensor device) required for the operation of application software after communication between the portable terminal 10 and the mobile device 20 is established, if a sensor device for acquiring the data exists in each of them, the portable terminal 10 selects whether to use sensor information acquired by a sensor device in the portable terminal 10 or to use sensor information acquired by a sensor device in the mobile device 20 based on predetermined conditions, and performs predetermined control processing by the application software by using the selected sensor information.

Examples of the above-described sensor device include a GPS sensor, a motion sensor, a heart rate sensor, a blood pressure sensor, a temperature sensor, an air pressure sensor, a gravity direction sensor, a brightness sensor, a vehicular speed (rotation speed) sensor, and a direction sensor. Also, examples of the above-described sensor information include the location of a sensor itself, a movement direction, a heart rate, a blood pressure, a surrounding temperature (body temperature), the degree of tilting, the brightness of a surrounding environment, and a vehicular speed, which are acquired by the above-described sensors.

Moreover, examples of the above-described predetermined conditions include a condition that a measurement accuracy of sensor information acquisition by a sensor in the portable terminal 10 is compared with the measurement accuracy of sensor information acquisition by a sensor in a communication partner and, based on the comparison result, information is selected which is acquired by a sensor in a device that can acquire sensor information satisfying accuracy required by the above-described application.

In addition, there is another condition that a device that can acquire sensor information at time intervals required by the above-described application is selected. More specifically, if one device is to update sensor information every five seconds and the other device is to update sensor information every fifteen seconds when the application makes a request for sensor information every ten seconds, sensor information is selected which is acquired by a sensor in the device that acquires sensor information every five seconds.

Moreover, there is yet another condition that the usage status of the portable terminal 10 is compared with the usage status of a communication partner, and sensor information acquired by a sensor in one of them is selected based on the comparison result. More specifically, each remaining time for which these devices can be continuously operated is estimated from their connection methods for wireless communication and their battery remaining amounts and, based on the remaining times, sensor information is selected which is acquired by a sensor in a device that can be used longer than the amount of time required by the above-described application.

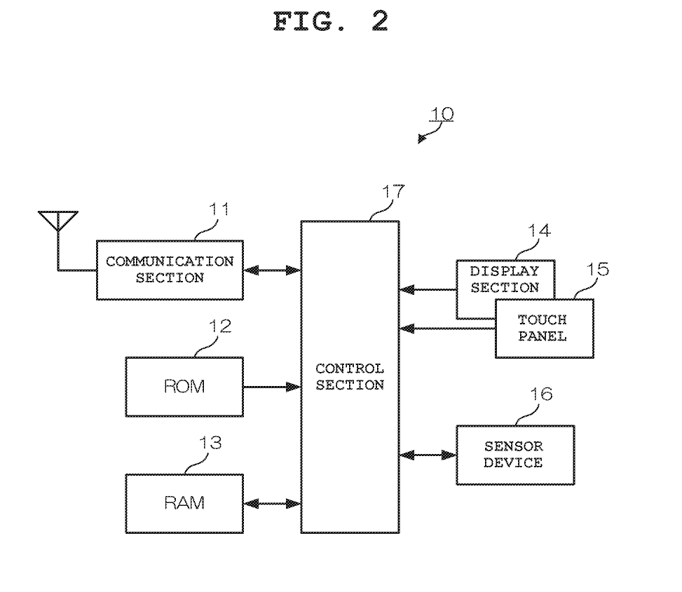

FIG. 2 is a block diagram showing the structure of the portable terminal 10 according to the embodiment. In FIG. 2, the portable terminal 10 includes a communication section 11, a ROM (Read Only Memory) 12, a RAM (Random Access Memory) 13, a display section 14, a touch panel 15, a sensor device 16, and a control section 17.

The communication section 11 establishes the wireless communication 100 with the mobile device 20, and transmits or receives data to or from the mobile device 20. Also, the communication section 11 establishes the wireless communication 101 for a connection to a mobile communications network, and performs voice communication or data communication. The ROM 12 has stored therein a program that is executed by the control section 19 described later, various parameters required for operations based on the program, etc. The RAM 13 has recorded therein personal information regarding the user, image data, various files, etc.

In particular, in this embodiment, the RAM 13 has an application software table 50 and a connected-device table 60 described later. The application software table 50 indicates sensor information and an update interval required for each piece of application software. The connected-device table 60 indicates, for each mobile device, a method for connection thereto, a manufacturer URL, a product ID, acquirable sensor information, a shortest interval for sensor information acquisition, and a remaining battery level at connection start timing. Details of the application software table 50 and the connected-device table 60 are described later.

The display section 14 is constituted by a liquid crystal display, an organic EL (Electro Luminescence) display, or the like, and displays icons associated with specific functions and applications, application screens, various types of menu screens, etc. The touch panel 15 is arranged and laminated on the display section 14, and detects direct contact by a finger or a stylus (pen) or its approach. The sensor device 16 includes at least one of a GPS sensor, a motion sensor, a heart rate sensor, a blood pressure sensor, a temperature sensor, an air pressure sensor, a gravity direction sensor, a brightness sensor, a vehicular speed (rotation speed) sensor, and a direction sensor.

The control section 17 refers to the connected-device table 60 before executing application software, and thereby acquires data associated with the device name of each mobile device 20 connected to the portable terminal 10, that is, a connection method, a manufacturer URL, a product ID, acquirable sensor information, a shortest acquisition interval, and a remaining battery level at connection start timing.

Also, the control section 17 refers to the homepage or the like of the manufacturer of the connected mobile device 20 based on the manufacturer URL and the product ID, and acquires information regarding the measurement accuracy of a sensor device mounted in the mobile device 20. Then, the control section 17 compares information regarding the measurement accuracy of a sensor device mounted in the portable terminal 10 with the information regarding the measurement accuracy of the sensor device mounted in the mobile device 20, and judges which sensor device is used based on the comparison result.

Moreover, the control section 17 refers to the application software table 50, and acquires sensor information and a sensor information update interval required for the application software. Then, the control section 17 compares the shortest interval for sensor information acquisition by the sensor device mounted in the portable terminal 10 with the sensor information update interval required for the application software, and judges which sensor device is used based on the comparison result.

Furthermore, the control section 17 estimates the amount of time for which the connected device (mobile device 20) can be continuously operated, based on the connection method and the remaining battery level. Then, the control section 17 judges whether the connected device (mobile device 20) can be used longer than a predetermined time required by the application, and judges which sensor device is used based on the comparison result.

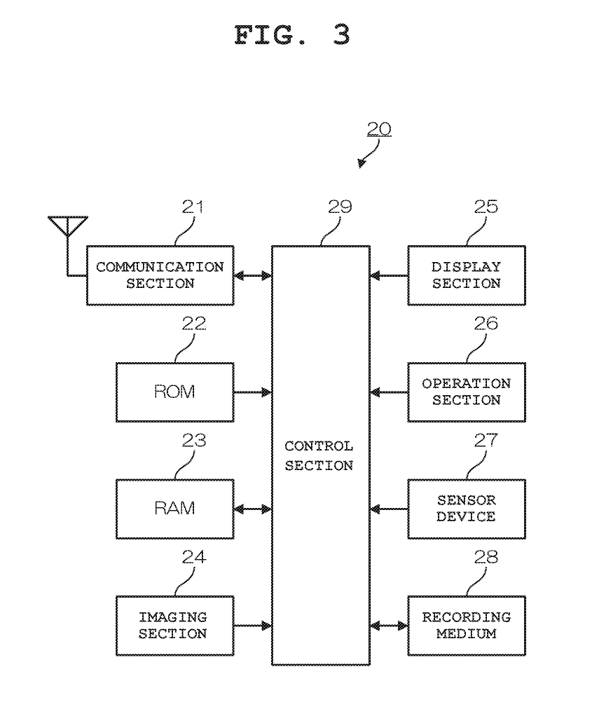

FIG. 3 is a block diagram showing the structure of the mobile device 20 according to the embodiment. Note that in the descriptions below, the mobile device 20 is a digital camera 20. In FIG. 3, the digital camera 20 includes a communication section 21, a ROM 22, a RAM 23, an imaging section 24, a display section 25, an operation section 26, a sensor device 27, a recording medium 28, and a control section 29.

The communication section 21 establishes the wireless communications 100 and 102 with the portable terminal 10 and the network 40, and transmits or receives data. The ROM 22 has stored therein a program that is executed by the control section 29 described later, various parameters required for operations based on the program, etc. The RAM 23 is used as a buffer memory that temporarily stores image files of images captured by the imaging section 24, and is also used as a working memory for the control section 29.

The display section 25 is constituted by a liquid crystal display, an organic EL (Electro Luminescence) display, or the like, and displays icons associated with specific functions and applications, application screens, various types of menu screens, etc. The operation section 26 includes a plurality of operation keys, such as a power switch, a shutter switch, a zoom switch, a mode key, a set key, and a cross key, and outputs an operation signal according to the user's key operation.

The sensor device 27 includes at least one of a GPS sensor, a motion sensor, a heart rate sensor, a blood pressure sensor, a temperature sensor, an air pressure sensor, a gravity direction sensor, a brightness sensor, a vehicular speed (rotation speed) sensor, and a direction sensor. The storage medium 28 stores image files of captured images.

The control section 29 controls the operation of each section by executing the program stored in the above-described ROM 22. In particular, in this embodiment, the control section 29 establishes a connection by the wireless communication 100 in response to a connection request from the portable terminal 10, and transmits information for identifying the device, such as the device name. Also, in response to a request from the portable terminal 10, the control section 29 transmits sensor information acquired by the sensor device 27 at predetermined update intervals.

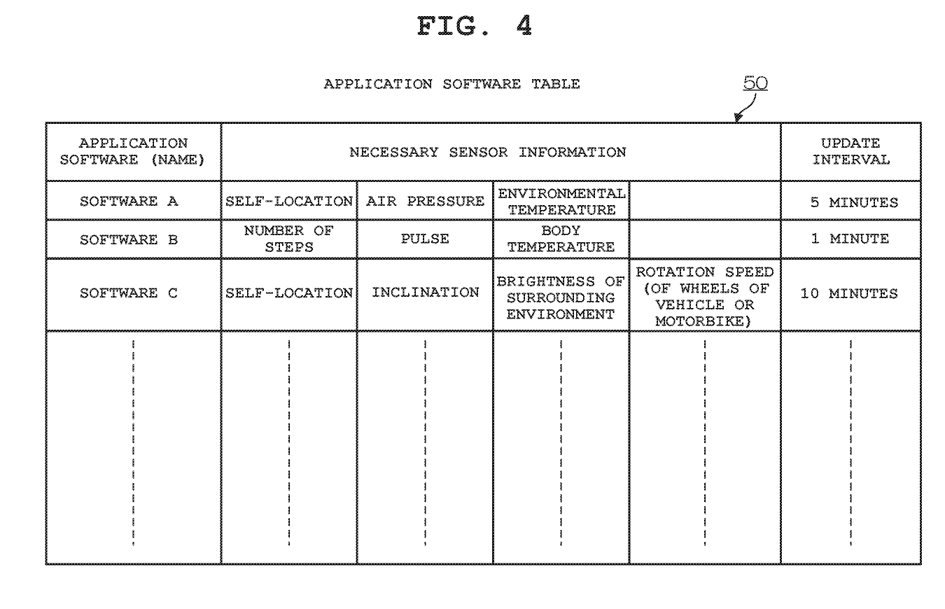

FIG. 4 is a diagram showing the configuration of the application software table 50 according to the embodiment. In FIG. 4, the application software table 50 is constituted by sensor information for each piece of application software (name) which is required by each piece of application software, and update intervals required by each piece of application software.

In the example in FIG. 4, for the application software “SOFTWARE A”, “SELF-LOCATION”, “AIR PRESSURE” and “ENVIRONMENTAL TEMPERATURE” have been listed as required sensor information, and “5 MINUTES” has been listed as an interval for updating the sensor information. That is, software A requires “SELF-LOCATION”, “AIR PRESSURE” and “ENVIRONMENTAL TEMPERATURE” as sensor information every five minutes.

Also, for the application software “SOFTWARE B”, “NUMBER OF STEPS”, “PULSE”, AND “BODY TEMPERATURE” have been listed as required sensor information, and “1 MINUTE” has been listed as an interval for updating the sensor information. That is, software B requires “NUMBER OF STEPS”, “PULSE”, AND “BODY TEMPERATURE” as sensor information every minute.

Similarly, for the application software “SOFTWARE C”, “SELF-LOCATION”, “INCLINATION”, “BRIGHTNESS OF SURROUNDING ENVIRONMENT” and “ROTATION SPEED (OF WHEELS OF VEHICLE OR MOTORBIKE)” have been listed as required sensor information, and “10 MINUTES” has been listed as an interval for updating the sensor information. That is, software C requires “SELF-LOCATION”, “INCLINATION”, “BRIGHTNESS OF SURROUNDING ENVIRONMENT” and “ROTATION SPEED (OF WHEELS OF VEHICLE OR MOTORBIKE)” as sensor information every ten minutes.

As a result of this configuration, by referring to the application software table 50 before executing application software, the control section 17 of the portable terminal 10 can acquire required sensor information and a required update interval in accordance with the application software to be executed.

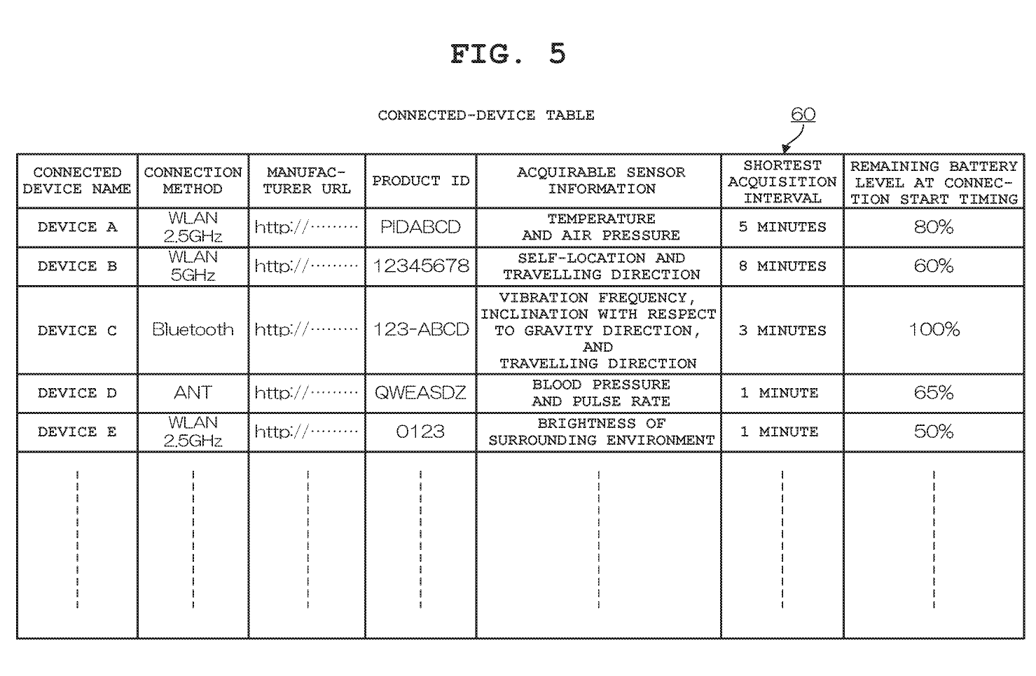

FIG. 5 is a diagram showing the configuration of the connected-device table 60 according to the embodiment. In FIG. 5, the connected-device table 60 is constituted by information for each connected device (mobile device 20), such as a method for connection to a device, a manufacturer URL, a product ID, acquirable sensor information, a shortest acquisition interval, and a remaining battery level at connection start timing.

In the example in FIG. 5, for the connected device “DEVICE A”, the connection method “WLAN 2.5 GHz”, the manufacturer URL “http:// . . . ”, the product ID “PIDABCD”, the acquirable sensor information “TEMPERATURE AND AIR PRESSURE”, the shortest acquisition interval “5 MINUTES”, and the remaining battery level at connection start timing “80%” have been listed.

Also, for the connected device “DEVICE B”, the connection method “WLAN 5 GHz”, the manufacturer URL “http:// . . . ”, the product ID “12345678”, the acquirable sensor information “SELF-LOCATION AND TRAVELLING DIRECTION”, the shortest acquisition interval “8 MINUTES”, and the remaining battery level at connection start timing “60%” have been listed. Moreover, for the connected device “DEVICE C”, the connection method “Bluetooth (registered trademark)”, the manufacturer URL “http:// . . . ”, the product ID “123-ABCD”, the acquirable sensor information “VIBRATION FREQUENCY, INCLINATION WITH RESPECT TO GRAVITY DIRECTION, AND TRAVELLING DIRECTION”, the shortest acquisition interval “3 MINUTES”, and the remaining battery level at connection start timing “100%” have been listed.

Furthermore, for the connected device “DEVICE D”, the connection method “ANT”, the manufacturer URL “http:// . . . ”, the product ID “QWEASDZ”, the acquirable sensor information “BLOOD PRESSURE AND PULSE RATE”, the shortest acquisition interval “1 MINUTE”, and the remaining battery level at connection start timing “65%” have been listed. Still further, for the connected device “DEVICE E”, the connection method “WLAN 2.5 GHz”, the manufacturer URL “http:// . . . ”, the product ID “0123”, the acquirable sensor information “BRIGHTNESS OF SURROUNDING ENVIRONMENT”, the shortest acquisition interval “1 MINUTE”, and the remaining battery level at connection start timing “50%” have been listed.

Note that the above-described remaining battery level at connection start timing denotes the remaining battery level of a corresponding device (mobile device 20) acquired therefrom when the portable terminal 10 is connected to it, and is a value that may be varied every time a connection is established. That is, when connected to a device (mobile device 20), the control section 17 of the portable terminal 10 acquires a remaining battery level from this device (mobile device 20) and stores it in the connected-device table 60.

The control section 17 of the portable terminal 10 refers to the connected-device table 60 before executing application software, and thereby acquires data associated with the device name of each device (mobile device 20) connected to the portable terminal 10, that is, a connection method, a manufacturer URL, a product ID, acquirable sensor information, a shortest acquisition interval, and a remaining battery level at connection start timing.

The manufacturer URL and the product ID are used to refer to the homepage or the like of the manufacturer of a corresponding device (mobile device 20) and acquire information regarding the measurement accuracy of the device (mobile device 20).

The control section 17 of the portable terminal 10 estimates, based on the connection method and the remaining battery level, the amount of time for which the corresponding device (mobile device 20) can be continuously operated. Then, the control section 17 judges whether the device (mobile device 20) can be used longer than a predetermined time required by the application, and judges which of the sensor devices of the portable terminal 10 and the device (mobile device 20) is used based on the judgment result.

### B. Operations of Embodiment

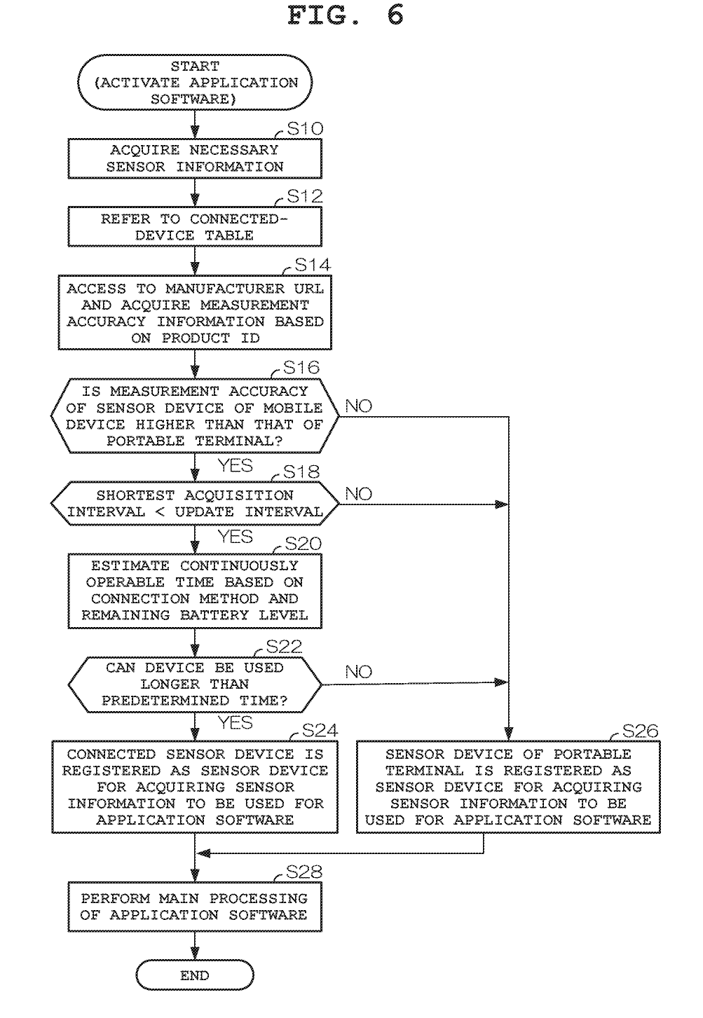

Next, operations of the above-described embodiment are described. FIG. 6 is a flowchart for describing these operations of the portable terminal 10 according to the embodiment. Note that, here, the portable terminal 10 and the mobile device 20 have already established the wireless communication 100 by using Bluetooth (registered trademark) or a wireless LAN such as WiFi (registered trademark) which is available to both the portable terminal 10 and the mobile device 20.

In the portable terminal 10, when application software specified (selected) by the user is activated, the control section 17 starts processing shown by the flowchart in FIG. 6. First, the control section 17 refers to the application software table 50 and thereby acquires sensor information required by the activated application software (Step S10). For example, in a case where software A shown in FIG. 4 has been activated, the required sensor information is information regarding a self-location, air pressure, and environmental temperature.

Next, the control section 17 refers to the connected-device table 60 and thereby acquires a manufacturer URL and a product ID associated with the device name of the connected mobile device 20 (Step S12). Subsequently, the control section 17 accesses to the acquired manufacturer URL and acquires the measurement accuracy information of the sensor device 27 of the mobile device 20 based on the product ID (Step S14).

Then, the control section 17 judges whether the measurement accuracy of the sensor device 27 of the mobile device 20 is higher than the measurement accuracy of the sensor device 16 of the portable terminal 10, based on the measurement accuracy information of the sensor device 27 of the mobile device 20 (Step S16).

When judged that the measurement accuracy of the sensor device 16 of the portable terminal 10 is higher than the measurement accuracy of the sensor device 27 of the mobile device 20 (NO at Step S16), the control section 17 selects the sensor device having the higher measurement accuracy, that is, the sensor device 16 of the portable terminal 10 as a sensor device for acquiring sensor information to be used for the application software (Step S26).

Conversely, when judged that the measurement accuracy of the sensor device 27 of the mobile device 20 is higher than the measurement accuracy of the sensor device 16 of the portable terminal 10 (YES at Step S16), the control section 17 judges whether the shortest interval for sensor information acquisition by the mobile device 20, which has been acquired from the connected-device table 60, is shorter than a sensor information update interval required by the activated application software (Step S18).

In a case where the shortest interval for sensor information acquisition by the mobile device 20 is longer than the sensor information update interval required by the activated application software (NO at Step S18), the supply of sensor information from the mobile device 20 to the application software is insufficient, and therefore the control section 17 selects the sensor device 16 of the portable terminal 10 as a sensor device for acquiring sensor information to be used for the application software (Step S26).

Conversely, in a case where the shortest interval for sensor information acquisition by the mobile device 20 is shorter than the sensor information update interval required by the activated application software (YES at Step S18), the supply of sensor information from the mobile device 20 to the application software is sufficient, and therefore the control section 17 estimates the amount of time for which the mobile device 20 can be continuously operated, based on the connection method with respect to the mobile device 20 and the remaining battery level which have been acquired from the connected-device table 60 (Step S20).

Next, based on the estimated amount of time for which the mobile device 20 can be continuously operated, the control section 17 judges whether the mobile device 20 can be used longer than a predetermined time, such as the amount of time the application software is used (Step S22).

When judged that the mobile device 20 cannot be used longer than the predetermined time (NO at Step S22), since the battery of the mobile device 20 may run down while the application software is being executed, the control section 17 selects the sensor device 16 of the portable terminal 10 as a sensor device for acquiring sensor information to be used for the application software (Step S26).

Conversely, when judged that the mobile device 20 can be used longer than the predetermined time (YES at Step S22), since all the conditions regarding the measurement accuracy, the shortest acquisition interval, and the operable time for continuous operation are satisfied, the control section 17 selects the sensor device 27 of the connected mobile device 20 as a sensor device for acquiring sensor information to be used for the application software (Step S24).

In both cases where the sensor device 16 of the portable terminal 10 is selected or the sensor device 27 of the connected mobile device 20 is selected, the control section 17 proceeds to the main processing of the application software (Step S28).

In the main processing, the control section 17 performs predetermined processing using sensor information acquired by a sensor device selected from between the sensor device 16 of the portable terminal 10 and the sensor device 27 of the connected mobile device 20.

In the above-described embodiment, the application software table 50 shown in FIG. 4 and the connected-device table 60 shown in FIG. 5 are provided in the portable terminal 10. However, the present invention is not limited thereto, and a configuration may be adopted in which they are provided in the mobile device 20 and the above-described processing is applied in processing to be performed when application software is performed on the mobile device 20 side. Here, by the sensor device 16 or the sensor device 27 being selected before the application software is performed, a sensor device not selected can be set not to be operated. However, the present invention is not limited thereto, and a configuration may be adopted in which both sensor devices are continuously operated, and application software selects a sensor device whose sensor information is used and a sensor device whose sensor information is not used. In this configuration, negotiation (communication establishment) processing in activation and communication processing is not required to be repeatedly performed and sensor information can be immediately provided to application software to be performed.

Also, the present invention is not limited to the configuration of the above-described embodiment where the application software table 50 shown in FIG. 4 and the connected-device table 60 shown in FIG. 5 are provided in the portable terminal 10, and a configuration may be adopted in which they are provided in the server 30 on the network 40, and the server 30 provides information required to select a sensor device to be used, in response to a request from the portable terminal 10 or a request from the mobile device 20.

According to the above-described embodiment, when sensor information required for the operation of application software is to be acquired after communication between the portable terminal 10 and the mobile device 20 is established, if a sensor device which acquires this type of sensor information exists in each device, the portable terminal 10 performs predetermined control processing of the application software by using sensor information acquired by the sensor device of the mobile device 20 instead of sensor information acquired by its own sensor device under a predetermined condition. As a result of this configuration, suitable sensor information can be used.

Also, according to the above-described embodiment, the portable terminal 10 compares the measurement accuracy of its own sensor device 16 with the measurement accuracy of the sensor device 27 of the mobile device 20, and selects sensor information acquired by a sensor device having a higher measurement accuracy. By this configuration as well, suitable sensor information can be used.

Moreover, according to the above-described embodiment, the portable terminal 10 compares a shortest interval for sensor information acquisition by the sensor device 27 of the mobile device 20 with an update interval required by application software, and selects sensor information acquired by the sensor device 27 of the mobile device 20 when the shortest acquisition interval is shorter than the update interval. By this configuration as well, suitable sensor information can be used.

Furthermore, according to the above-described embodiment, the portable terminal 10 estimates the amount of time for which the mobile device 20 can be continuously operated, based on the connection method between the portable terminal 10 and the mobile device 20 and the remaining battery level of the mobile device 20, and selects sensor information acquired by the sensor device 27 of the mobile device 20 when the mobile device 20 can be used longer than a predetermined time. By this configuration as well, suitable sensor information can be used.

While the present invention has been described with reference to the preferred embodiments, it is intended that the invention be not limited by any of the details of the description therein but includes all the embodiments which fall within the scope of the appended claims.

What is claimed is:

1. An information processing device, comprising:
a sensor which acquires sensor information based on an external environment;
a reception section which receives sensor information whose type is same as type of the sensor information that is acquired by the sensor, from outside the information processing device; and
a control section,
wherein the control section selects one of the sensor information that is acquired by the sensor and the sensor information that is received by the reception section, and performs predetermined control processing by using the selected sensor information.

2. The information processing device according to claim 1, wherein the control section compares accuracy of the sensor information that is acquired by the sensor with accuracy of the sensor information that is received by the reception section, and selects one of the sensor information that is acquired by the sensor and the sensor information that is received by the reception section based on a comparison result.

3. The information processing device according to claim 1, wherein the predetermined control processing is processing of requesting the sensor to acquire sensor information at a predetermined time interval, and
wherein the control section acquires an update interval of the sensor information that is received by the reception section, and selects the sensor information that is received by the reception section, when the update interval is shorter than the predetermined time interval.

4. The information processing device according to claim 1, wherein the control section compares a usage status of the sensor with a usage status of a device that is a sender of the sensor information to be received by the reception section, and selects one of the sensor information that is acquired by the sensor and the sensor information that is received by the reception section based on a comparison result.

5. The information processing device according to claim 4, wherein the usage status includes remaining battery level information.

6. The information processing device according to claim 5, wherein the remaining battery level information of the device serving as the sender is generated in consideration of an effect of power consumption of wireless communication means in the device serving as the sender.

7. An information processing method, comprising:
a selection step of selecting one of sensor information that is acquired by a sensor mounted in a device and sensor information that is received from outside; and
a control step of performing predetermined control processing by using the selected sensor information.

8. The information processing method according to claim 7, further comprising:
a comparison step of comparing accuracy of the sensor information that is acquired by the sensor with accuracy of the sensor information that is received from outside,
wherein the selection step selects one of the sensor information that is acquired by the sensor and the sensor information that is received from outside, based on a comparison result.

9. The information processing method according to claim 7, further comprising:
an acquisition step of acquiring an update interval of the sensor information that is received from outside,
wherein the predetermined control processing is processing of requesting the sensor to acquire sensor information at a predetermined time interval, and
wherein the selection step selects the sensor information that is received from outside, when the update interval acquired in the acquisition step is shorter than the predetermined time interval.

10. The information processing method according to claim 7, further comprising:
a comparison step of comparing a usage status of the sensor with a usage status of a device that is a sender of the sensor information to be received from outside,
wherein the selection step selects one of the sensor information that is acquired by the sensor and the sensor information that is received from outside, based on a comparison result in the comparison step.

11. A non-transitory computer-readable storage medium having stored thereon a program that is executable by a computer including a sensor which acquires sensor information based on an external environment and a reception section, the program being executable by the computer to actualize functions comprising:
a reception function for receiving sensor information whose type is same as type of the sensor information that is acquired by the sensor, from outside via the reception section;
a selection function for selecting one of the sensor information that is acquired by the sensor and the sensor information that is received from outside; and
a control function for performing predetermined control processing by using the sensor information selected by the selection function.

12. An information processing device, comprising:
a sensor which acquires sensor information based on an external environment;
a communication section which communicates externally; and
a control section,
wherein the control section makes an external request to transmit information required for selecting one of the sensor information that is acquired by the sensor and sensor information that is provided from outside, via the communication section,
wherein the control section controls the communication section to receive the information that is transmitted from outside in response to the request, and
wherein the control section performs predetermined control processing by selectively using one of the sensor information that is acquired by the sensor and the sensor information that is provided from outside, based on the information received by the communication section.

13. An information processing system constituted by an information processing device, a mobile device, and a server, wherein the information processing device comprises a first sensor which acquires first sensor information based on an external environment and a control section,
wherein the mobile device comprises a second sensor which acquires second sensor information based on an external environment,
wherein the server has sensor-related information regarding the first sensor and the second sensor, and comprises a transmission section which transmits information that is based on the sensor-related information and is required to select one of the first sensor information and the second sensor information to the information processing device in response to a request from the information processing device or the mobile device, and
wherein the control section of the information processing device performs predetermined control processing by selectively using one of the first sensor information and the second sensor information based on the information transmitted from the server.
